(19) United States
(12) Patent Application Publication
(10) Pub. No.: US 2024/0078925 A1
(43) Pub. Date: Mar. 7, 2024

(54) PERSONALIZING REMOTE LEARNING EXPERIENCES

(71) Applicant: AT&T Intellectual Property I, L.P., Atlanta, GA (US)

(72) Inventors: Stephen Griesmer, Westfield, NJ (US); Himanshu Ranpura, Edison, NJ (US)

(21) Appl. No.: 17/929,135

(22) Filed: Sep. 1, 2022

(51) Int. Cl. G09B 5/14; G09B 5/12

(52) U.S. Cl. CPC G09B 5/14; G09B 5/125

(57) ABSTRACT

In one example, a method includes receiving a selection of a learning activity by a student, retrieving a profile for the learning activity, retrieving a profile for the student, determining that no conflict exists between the profile for the learning activity and the profile for the student, and delivering, in response to the determining, the learning activity to a user endpoint device of the student, wherein the delivering includes granting the user endpoint device of the student a control over a network connected device that is located in a separate physical environment from the user endpoint device of the student.

The present disclosure relates generally to remote learning, and relates more particularly to devices, non-transitory computer-readable media, and methods for personalizing remote learning experiences based on student preferences and abilities.

### BACKGROUND

While remote learning has existed in various forms for many years, the COVID-19 pandemic truly propelled remote learning into the mainstream and spawned the development of many new and different educational platforms. Although most educational settings have now resumed traditional, in-person learning, the collective experience with remote learning has revealed many advantages and opportunities that can be leveraged in post-pandemic education.

### SUMMARY

In one example, the present disclosure describes a device, computer-readable medium, and method for supporting personalization of remote learning experiences based on student preferences and abilities. For instance, in one example, a method performed by a processing system including at least one processor includes receiving a selection of a learning activity by a student, retrieving a profile for the learning activity, retrieving a profile for the student, determining that no conflict exists between the profile for the learning activity and the profile for the student, and delivering, in response to the determining, the learning activity to a user endpoint device of the student, wherein the delivering includes granting the user endpoint device of the student a control over a network connected device that is located in a separate physical environment from the user endpoint device of the student.

In another example, a non-transitory computer-readable medium stores instructions which, when executed by a processing system, including at least one processor, cause the processing system to perform operations. The operations include receiving a selection of a learning activity by a student, retrieving a profile for the learning activity, retrieving a profile for the student, determining that no conflict exists between the profile for the learning activity and the profile for the student, and delivering, in response to the determining, the learning activity to a user endpoint device of the student, wherein the delivering includes granting the user endpoint device of the student a control over a network connected device that is located in a separate physical environment from the user endpoint device of the student.

In another example, a device includes a processing system including at least one processor and a computer-readable medium storing instructions which, when executed by the processing system, cause the processing system to perform operations. The operations include receiving a selection of a learning activity by a student, retrieving a profile for the learning activity, retrieving a profile for the student, determining that no conflict exists between the profile for the learning activity and the profile for the student, and delivering, in response to the determining, the learning activity to a user endpoint device of the student, wherein the delivering includes granting the user endpoint device of the student a control over a network connected device that is located in a separate physical environment from the user endpoint device of the student.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure may operate;

FIG. 2 illustrates a flowchart of an example method for supporting the personalization of remote learning experiences in accordance with the present disclosure; and

FIG. 3 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure supports the personalization of remote learning experiences. As discussed above, the collective experience with remote learning during the COVID-19 pandemic has revealed many advantages and opportunities that can be leveraged in post-pandemic education. For instance, remote learning provides more opportunities for students to interact with subject matter experts and to access locations and resources that might not otherwise be available in the students' in-person educational settings. As some examples, students may take virtual field trips to historic sites, museums, and other locations that might not be feasible to visit in person due to distance, cost, and/or other factors; students who lack access to the necessary equipment to perform an in-person science experiment may be able to perform the science experiment virtually (e.g., by remotely controlling the necessary equipment, which is physically located in another location); and students whose school districts do not provide instructions in particular subjects (e.g., specific languages, computer science, etc.) may be able to access instructions in these subjects through virtual classes. Access to pre-recorded classes and/or live classes presented in different time zones may provide students who work full time with the necessary flexibility to accommodate work and school in their schedules. Moreover, faculty at different educational institutions may have more opportunities to collaborate and develop intertwined and comprehensive curriculums that are available to a broader base of students.

Despite these advantages, however, remote learning is not without its drawbacks, and conventional remote learning may be more effective for some students than for others. For instance, during the COVID-19 pandemic, many students suffered from “screen fatigue” due to the many hours of participation in virtual classrooms via video conferencing and other applications, which in turn contributed to poor student engagement and social interaction. In addition, many remote learning platforms were plagued by technical issues such as power outages, inconsistent connectivity, hardware/software incompatibility, and other problems.

Examples of the present disclosure leverage the technology and communications capabilities that were developed during the COVID-19 pandemic to provide a remote learning system in which learning experiences can be personalized to different students' preferences and abilities. In one example, the remote learning system enables learning through interactive discussions, hands-on activities, lectures, and/or learning by reading. Learning activities may be stored in one or more databases. Profiles may be generated for each individual learning activity and may specify, for each learning activity, the learning style, level of difficulty, target age, and prerequisites. Similarly, student profiles may be stored in a database and may specify, for each student, preferred learning style(s), learning history (for prerequisites), age, and preferred level of difficulty. Then, when a student selects a learning activity, the learning activity's profile may be compared to the student's profile to verify that the learning activity is suitable for the student. The student's interaction and engagement with the learning activity may be monitored to learn the student's preferences and learning styles, as well as to refine future assessments of suitability. If a learning activity is determined to be unsuitable for a student, a different learning activity (e.g., perhaps a similar learning activity presented in a different learning style or level of difficulty) can be recommended.

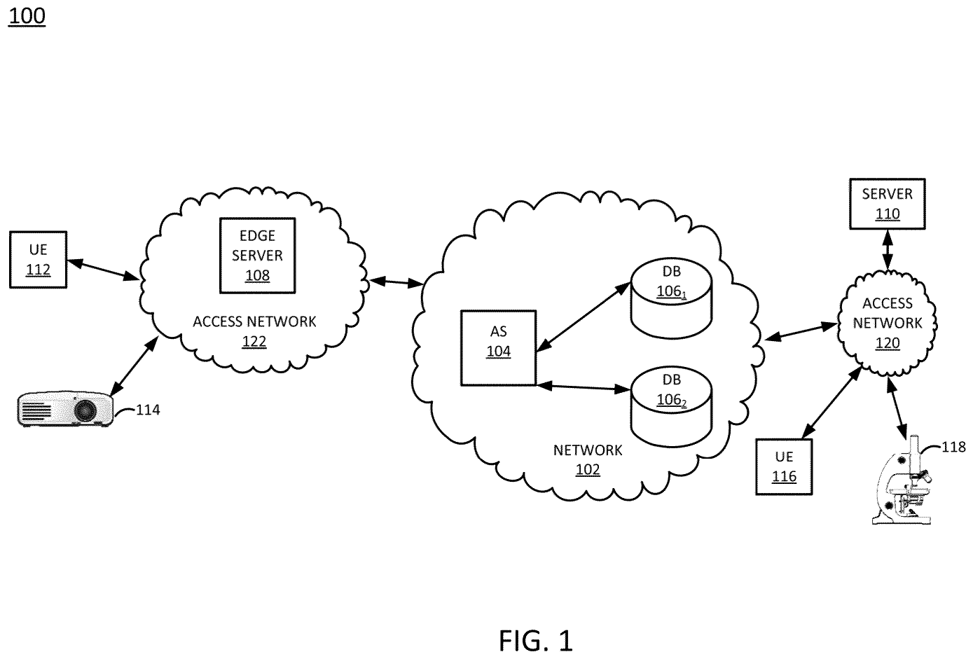

Thus, examples of the present disclosure provide a more targeted and personalized experience for students participating in remote or virtual learning. Educators can also be provided with feedback that can be integrated into the selection of learning activities for individual students. In this way, students can be provided with a greater range of high quality learning experiences that might not be available to them through in-person learning. These and other aspects of the present disclosure are described in greater detail below in connection with the examples of FIGS. 1-3.

To further aid in understanding the present disclosure, FIG. 1 illustrates an example system 100 in which examples of the present disclosure may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, and the like), a long term evolution (LTE) network, 5G and the like related to the current disclosure. It should be noted that an IP network is broadly defined as a network that uses Internet Protocol to exchange data packets. Additional example IP networks include Voice over IP (VoIP) networks, Service over IP (SoIP) networks, and the like.

In one example, the system 100 may comprise a network 102, e.g., a telecommunication service provider network, a core network, or an enterprise network comprising infrastructure for computing and communications services of a business, an educational institution, a governmental service, or other enterprises. The network 102 may be in communication with one or more access networks 120 and 122, and the Internet (not shown). In one example, network 102 may combine core network components of a cellular network with components of a triple play service network; where triple-play services include telephone services, Internet or data services and television services to subscribers. For example, network 102 may functionally comprise a fixed mobile convergence (FMC) network, e.g., an IP Multimedia Subsystem (IMS) network. In addition, network 102 may functionally comprise a telephony network, e.g., an Internet Protocol/Multi-Protocol Label Switching (IP/MPLS) backbone network utilizing Session Initiation Protocol (SIP) for circuit-switched and Voice over internet Protocol (VoIP) telephony services. Network 102 may further comprise a broadcast television network, e.g., a traditional cable provider network or an internet Protocol Television (IPTV) network, as well as an Internet Service Provider (ISP) network.

In one example, the access networks 120 and 122 may comprise broadband optical and/or cable access networks, Local Area Networks (LANs), wireless access networks (e.g., an IEEE 802.11/Wi-Fi network and the like), cellular access networks, Digital Subscriber Line (DSL) networks, public switched telephone network (PSTN) access networks, 3 rd party networks, and the like. For example, the operator of network 102 may provide a cable television service, an IPTV service, or any other types of telecommunication service to subscribers via access networks 120 and 122. In one example, the access networks 120 and 122 may comprise different types of access networks, may comprise the same type of access network, or some access networks may be the same type of access network and other may be different types of access networks. In one example, the network 102 may be operated by a telecommunication network service provider. The network 102 and the access networks 120 and 122 may be operated by different service providers, the same service provider or a combination thereof, or may be operated by entities having core businesses that are not related to telecommunications services, e.g., corporate, governmental or educational institution LANs, and the like.

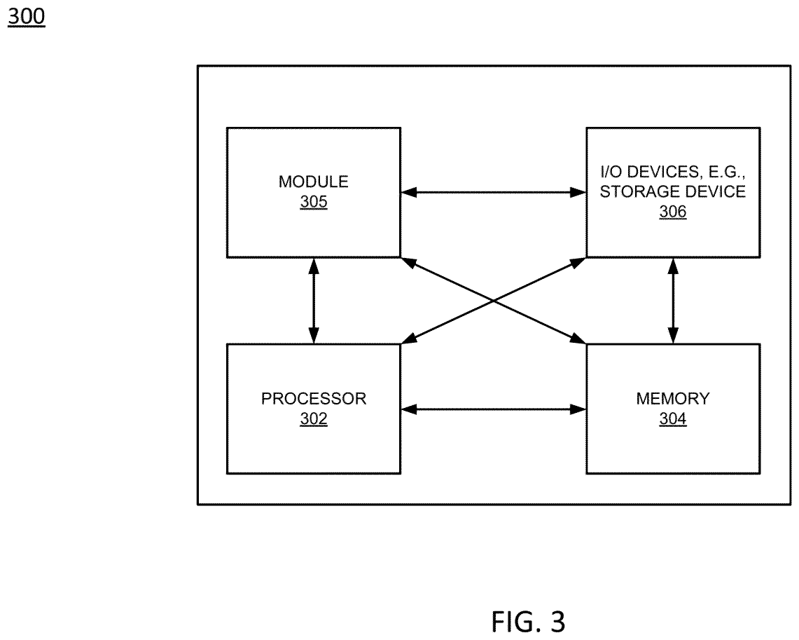

In accordance with the present disclosure, network 102 may include an application server (AS) 104, which may comprise a computing system or server, such as computing system 300 depicted in FIG. 3, and may be configured to provide one or more operations or functions in connection with supporting the personalization of remote learning experiences. For instance, the AS 104 may support a service through which a user can browse and request access to a plurality of remote learning experiences, as discussed in greater detail below. The network 102 may also include one or more databases (DBs) 106₁-106₂ (hereinafter individually referred to as a “database 106” or collectively referred to as “databases 106”) that are communicatively coupled to the AS 104.

In one example, the AS 104 may comprise a physical storage device (e.g., a database server), to store data for a plurality of remote learning activities. The remote learning activities may comprise media (e.g., audio and/or video files) that can be accessed and played back via a network-connected user endpoint device (e.g., a personal computer, a laptop computer, a tablet computer, a smart phone, a gaming console, or the like). In one example, the media files may contain educational activities or lessons, such as interactive discussions, hands-on activities, lectures, and/or learning by reading activities pertaining to a particular subject.

In one example, each remote learning activity may be tagged with metadata describing the learning style of the remote learning activity (e.g., interactive discussion, hands-on activity, lecture, and/or learning by reading), the level of difficulty of the remote learning activity (e.g., beginner/intermediate/advanced; level 1/level 2/level 3; easy/medium/hard; etc.), target age level (e.g., pre-kindergarten/early elementary/middle school/high school/college/post-graduate/professional; ages 5-8/ages 9-12/ages 13-17, ages 18+, etc.), and prerequisites (e.g., other remote learning activities or their equivalents that a student must complete first; educator approval or recommendation, etc.). Collectively, the metadata may form an activity profile for an associated remote learning activity. The metadata for a learning activity may be selected by an expert or educator with knowledge of the learning activity.

In one example, the AS 104 may store multiple learning activities that teach versions of the same subject matter or lesson, with the same level of difficulty, target age, and prerequisites, but presented in different learning styles. For instance, a first learning activity may be structured to teach the physics of an inclined plane to high school students through a reading activity, while a second learning activity may be structured to teach the physics of an inclined plane to high school students through a hands-on activity.

In a further example, the AS 104 may also store student profiles. In one example, the student profiles may actually be stored in the DB 106, but the DB 106 may be resident on the AS 104. For instance, students may subscribe to the service supported by the AS 104 and, upon registration with the service, complete a profile. A profile for a student may indicate the student's preferred style of learning (e.g., interactive discussion, hands-on activity, lecture, and/or learning by reading), the student's learning history (e.g., remote learning activities that the student has previously completed through the AS 104, offline educational history such as in-person classes completed, etc.), the student's age (e.g., age or grade level), and the student's preferred level of difficulty (e.g., beginner/intermediate/advanced; level 1/level 2/level 3; easy/medium/hard; etc.). The student profile may be created by the student, by a parent or caregiver of the student, or by an educator of the student. However, in one example, regardless of who creates the student profile, an educator will review and optionally update the student profile over time (e.g., periodically, as the student passes certain educational milestones, or the like).

In one example, the DBs 106 may store the remote learning activities and/or student profiles, and the AS 104 may retrieve the remote learning activities and/or student profiles from the DBs 106 when needed (e.g., when a student requests access to a remote learning activity). For ease of illustration, various additional elements of network 102 are omitted from FIG. 1.

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure. Thus, although a single AS 104 and two DBs 106 are illustrated in FIG. 1, it should be noted that any number of servers and any number of databases may be deployed, and which may operate in a distributed and/or coordinated manner as a processing system to perform operations in connection with the present disclosure.

In one example, access network 122 may include an edge server 108, which may comprise a computing system or server, such as computing system 300 depicted in FIG. 3, and may be configured to provide one or more operations or functions for in connection with supporting a network connected application.

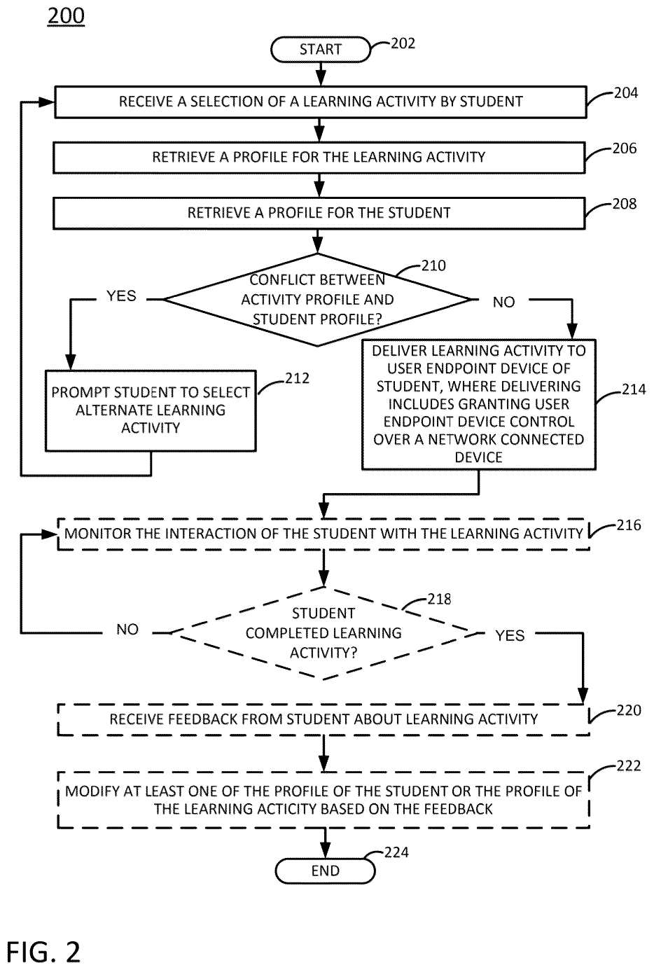

In one example, the access network 120 may be in communication with a server 110 and with one or user endpoint devices (UEs), e.g., UEs 116 and 118. Similarly, access network 122 may be in communication with UEs, e.g., UEs 112 and 114. Access networks 120 and 122 may transmit and receive communications between server 110, user endpoint devices 112, 114, 116, and 118, application server(s) (AS) 104, components of network 102, devices reachable via the Internet in general, and so forth. In one example, at least some of the UEs 112, 114, 116, and 118 may comprise a computing device, such as a smart phone, a wearable computing device (e.g., smart glasses, a virtual reality (VR) headset or other types of head mounted display, or the like), a laptop computer, a tablet computer, a personal computer, a gaming console, or the like. In one example, any or all of the UEs 112, 114, 116, and 118 may comprise a computing system or device, such as computing system 300 depicted in FIG. 3, and may be configured to provide one or more operations or functions in connection with examples of the present disclosure for supporting the personalization of remote learning experiences, as described herein. For instance, an example method 200 for supporting the personalization of remote learning experiences is illustrated in FIG. 2 and described in greater detail below.

In a further example, at least some of the UEs 112, 114, 116, and 118 may comprise may comprise network-connected device that can be operated remotely to carry out a remote learning activity. For instance, at least some of the UEs 112, 114, 116, and 118 may comprise Internet of Things (IoT) devices, multimedia devices (e.g., projectors, cameras, speakers, microphones, etc.), scientific equipment (e.g., microscopes, oscilloscopes, spectrometers, telescopes, etc.). As a non-limiting example, UE 114 of FIG. 1 comprises a projector 114, while UE 118 comprises a microscope.

In one example, server 110 may comprise a network-based server for providing services in connection with the personalization of remote learning experiences. In this regard, server 110 may comprise the same or similar components as those of AS 104 and may provide the same or similar functions. Thus, any examples described herein with respect to AS 104 may similarly apply to server 110, and vice versa. In particular, server 110 may be a component of a system for providing services in connection with the personalization of remote learning experiences which is operated by an entity that is not a telecommunications network operator. For instance, a provider of an application for supporting the personalization of remote learning experiences may operate server 110 and may also operate edge server 108 in accordance with an arrangement with a telecommunication service provider offering edge computing resources to third-parties. However, in another example, a telecommunication network service provider may operate network 102 and access network 122, and may also provide a system via AS 104 and edge server 108. For instance, in such an example, the system embodied in the AS 104 may comprise an additional service that may be offered to subscribers, e.g., in addition to network access services, telephony services, traditional television services, media content delivery service, and so forth.

It should be noted that the system 100 has been simplified. Thus, it should be noted that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, a content distribution network (CDN) and the like. For example, portions of network 102, access networks 120 and 122, and/or Internet may comprise a content distribution network (CDN) having ingest servers, edge servers, and the like for packet-based streaming of video, audio, or other content. Similarly, although only two access networks, 120 and 122 are shown, in other examples, access networks 120 and/or 122 may each comprise a plurality of different access networks that may interface with network 102 independently or in a chained manner. In addition, as described above, the functions of AS 104 may be similarly provided by server 110, or may be provided by AS 104 in conjunction with server 110. For instance, AS 104 and server 110 may be configured in a load balancing arrangement, or may be configured to provide for backups or redundancies with respect to each other, and so forth. Thus, these and other modifications are all contemplated within the scope of the present disclosure.

To further aid in understanding the present disclosure, FIG. 2 illustrates a flowchart of an example method 200 for supporting the personalization of remote learning experiences in accordance with the present disclosure. In one example, the method 200 may be performed by a server, such as application server 104 illustrated in FIG. 1. However, in other examples, the method 200 may be performed by another device, such as the processor 302 of the system 300 illustrated in FIG. 3. For the sake of example, the method 200 is described as being performed by a processing system.

The method 200 begins in step 202. In step 204, the processing system may receive a selection of a learning activity by a student. In one example, the learning activity comprises a remote learning activity, i.e., a learning activity that the student participates in from a remote location, using a network connected device to access the learning activity. For instance, the learning activity may comprise a media file (e.g., a video of a lesson) that is stored in a database, where the student may download or stream the media file from the database for play back on his or her user endpoint device.

In one example, the learning activity is one of a plurality of learning activities stored in a learning activity database. For instance, a service for supporting remote learning may maintain one or more databases of remote learning activities that may be accessed by subscribers to the service. In one example, the student may browse the plurality of learning activities before selecting the remote learning activity. For instance, the student may use his or her user endpoint device to access an application server that provides a search function for the plurality of learning activities. The student may provide the search function with one or more keywords, and the search function may return one or more learning activities whose profiles or metadata match the keywords. The student may then select the learning activity from the results returned by the search function.

In another example, the student may browse the plurality of learning activities by drilling down through a series of categories. For instance, when the student logs into the service, the student may be provided with a menu that groups the plurality of learning activities into a plurality of broad categories (e.g., “science,” “languages,” “math,” “music,” etc.). Selecting any of these broad categories may narrow down the plurality of learning activities to a smaller set of more specific activities (e.g., selecting “science” could provide more specific options such as “biology,” “chemistry,” “physics,” etc.). By continuing to select more specific activities each time where new options are presented, the student may be able to select a specific learning activity (e.g., selecting “biology” may present more specific options of “genetics,” “physiology,” “immunology,” and the like, while selecting “genetics” may present learning activities such as instructions on how to complete a Punnett square, definitions of genotypes and phenotypes, demonstrations on how to model chromosomal inheritance, and the like).

In another example, the student may be participating in a specific curriculum where learning activities that must be completed to fulfill the curriculum requirements are dictated by an educator (e.g., the student's teacher). In this case, when the student logs into the service, the student may be presented with a list of one or more learning activities that are required by the curriculum and which the student has yet to complete. The student may then select the learning activity from the list.

In step 206, the processing system may retrieve a profile for the learning activity (i.e., the learning activity that is selected in step 204). As discussed above, each learning activity of the plurality of learning activities may be associated with a set of metadata describing the learning activity, where the set of metadata collectively forms a profile for the learning activity. In one example, the profile for a learning activity may specify one or more of the following attributes: the learning style of the learning activity (e.g., interactive discussion, hands-on activity, lecture, and/or learning by reading), the level of difficulty of the learning activity (e.g., beginner/intermediate/advanced; level 1/level 2/level 3; easy/medium/hard; etc.), the target age level of the learning activity (e.g., pre-kindergarten/early elementary/middle school/high school/college/post-graduate/professional; ages 5-8/ages 9-12/ages 13-17, ages 18+, etc.), and one or more prerequisites for the learning activity (e.g., other learning activities or their equivalents that a user must complete first; educator approval or recommendation, etc.). In further examples, the profile may specify other information as well.

In one example, the profile may be retrieved by parsing a media file containing the learning activity for the metadata describing the learning activity. In another example, the profile may be contained within a separate metadata file (i.e., separate from the media file) that is linked to the media file.

In step 208, the processing system may retrieve a profile for the student. As discussed above, students may have a profile that they either create for themselves or have someone else (e.g., a parent, a caregiver, or an educator) create for them. The profile may be periodically updated and curated by an educator. In one example, the profile for a student may specify one or more of the following attributes: the student's preferred style of learning (e.g., interactive discussion, hands-on activity, lecture, and/or learning by reading), the student's learning history (e.g., remote learning activities that the student has previously completed through the service, offline educational history such as in-person classes completed, etc.), the student's age (e.g., age or grade level), and the student's preferred level of difficulty (e.g., beginner/intermediate/advanced; level 1/level 2/level 3; easy/medium/hard; etc.).

In one example, the student profile may be automatically loaded to the processing system when the student logs into the service. In another example, the student may provide the profile in response to a prompting by the processing system. For instance, where multiple students may share a single account to access the service (e.g., multiple children belonging to the same family, to the same class in school, or the like), separate profiles may be created under the single account for the individual students. Thus, in this case, the student may indicate which profile associated with the account belongs to the student.

In step 210, the processing system may automatically determine whether a conflict exists between the profile for the learning activity and the profile for the student. In one example, determining whether a conflict exists comprises comparing the profile for the learning activity to the profile for the student to determine whether the learning activity is a good match for the student. For instance, at least some of the attributes of the profile of the learning activity may be directly compared to attributes of the student; if any pairs of directly compared attributes fail to match, a conflict may be identified. As an example, the learning style of the learning activity may be compared to the preferred learning style of the student. If the learning style of the learning activity is “lecture,” but the preferred learning style of the student is “hands-on activity” (or if the profile of the student indicates that the student does not learn effectively from lectures), then a conflict may be identified. Similarly, if the learning activity has a prerequisite of “Physics 101,” and the learning history of the student does not include “Physics 101,” then a conflict may be identified. As another example, if the learning activity has a target age level of “ages 10+,” and the age of the student is seven, then a conflict may be identified.

In one example, a mismatch between any one pair of attributes may be sufficient to determine a conflict between the profile of the learning activity and the profile of the student. In another example, however, a conflict between the profile of the learning activity and the profile of the student may require a mismatch of more than one pair of attributes (e.g., at least x mismatches, where x can be 2, 3, 4, and the like). In another example, mismatches between certain attribute pairs may always result in a conflict between the profile of the learning activity and the profile of the student, even if there are no other mismatches between any other attribute pairs (e.g., if the learning history of the student does not include a perquisite for the learning activity, then this may always result in a conflict).

In one example, a conflict between the profile of the learning activity and the profile of the student that is automatically identified by the processing system may be verified by human oversight. For instance, the processing system may detect that the age of the student is below the target age level of the learning activity. However, some students may perform at higher age levels in certain subjects (e.g., a third grader may read at a fifth grade level). In such a case, rather than identify a conflict, the processing system may first contact an educator, a parent, or a caregiver indicated in the profile of the student. The educator, parent, or caregiver may be given an opportunity to override the mismatch, thereby preventing a conflict from being determined.

If the processing system determines in step 210 that a conflict does exist between the profile for the learning activity and the profile for the student, then the method 200 may proceed to step 212. In step 212, the processing system may prompt the student to select an alternate learning activity. In one example, the processing system may provide a list of one or more suggested learning activities (from the plurality of learning activities) that the student may select as the alternate learning activity. For instance, if the student selected a learning activity that included a lecture explaining the concept of an inclined plane, but the student's preferred learning style is hands-on activities, then the processing system may suggest a different learning activity that demonstrates the concept of an inclined plane through a hands-on activity. As discussed above, multiple instances of the same learning activity may be created and tailored to different learning styles, levels of difficulty, and/or target age ranges.

Similarly, if the student selected a learning activity that teaches French verb conjugation with a prerequisite that the student have first mastered a lesson on French pronouns, and the student's learning history does not indicate that the student has attempted the lesson on French pronouns, then the processing system may suggest the lesson on French pronouns. As another example, if the student selected a calculus lesson with a difficult level of “extremely hard,” but the student's preferred level of difficulty is “medium,” then the processing system may suggest a similar calculus lesson with a difficulty level of medium.

In one example, the processing system may present a dialog to the student that explains why the conflict was detected (e.g., “prerequisite not completed,” “learning style not preferred,” etc.). The processing system may also present the list of suggested learning activities along with reasons as to why each suggested learning activity may be better suited for the student (e.g., “needed as prerequisite for requested learning activity,” “preferred learning style,” etc.). This may assist the student in selecting an alternate learning activity that is better suited for the student's abilities and preferences.

Once the processing system has prompted the student to select an alternate learning activity, the processing system may return to step 204, and the processing system may proceed as described above to determine the suitability of the selected alternate learning activity.

Alternatively, if the processing system determines in step 210 that a conflict does not exist between the profile for the learning activity and the profile for the student, then the method 200 may proceed to step 214. In step 214, the processing system may deliver the learning activity to an endpoint device of the student, where the delivering includes granting the endpoint device of the student control over a network connected device that is located in a separate physical environment from the endpoint device of the student.

As discussed above, the learning activity may comprise a media file that contains an educational lesson. Thus, delivery of the learning activity to the endpoint device may comprise uploading the learning activity to the endpoint device in whole or in part (e.g., streaming the learning activity to the endpoint device). In another example, delivery of the learning activity may comprise sending a link to the endpoint device, whereby the endpoint device may access the learning activity remotely via the link.

As discussed above, delivering the learning activity to the endpoint device may include granting the endpoint device of the student with control over a network connected device that is located in a separate physical environment from the endpoint device of the student. The network connected device may be a device that is needed to complete the learning activity. For instance, if the learning activity requires the use of a microscope, and the student does not have a microscope at the location from which the user is participating in the learning activity, then the processing system may grant the endpoint device of the student control over a network connected microscope that is located in a remote location (e.g., a physical location other than the location from which the student is participating in the learning activity). By granting the user endpoint device of the student control over the microscope, the processing system may enable the endpoint device to remotely control operation of the microscope, at least temporarily. Other network connected devices or remote resources that the processing system may grant the endpoint device of the student access to may include multimedia devices (e.g., projectors, cameras, microphones, speakers, etc.), scientific devices (e.g., oscilloscopes, spectrometers, etc.), robots, drones, or other remotely controllable vehicles that can be controlled to carry out tasks or actions, electronic copies of documents (e.g., textbooks, novels, sheet music, copyrighted material, etc.), and electronic copies of other media (e.g., music, artwork, copyrighted material, etc.). In some cases, the processing system may have access to copyrighted material through one or more licenses.

In one example, the processing system may grant the user endpoint device of the student control over the network connected device by providing the user endpoint device with a password or passcode that enables control over the network connected device. For instance, the password or passcode may be a unique, one-time password or passcode that is generated each time a user endpoint device of a student requires access to the network connected device. If the user endpoint device of the student does not use the password or passcode to connect to the network connected device within some threshold period of time of the password or passcode being generated (e.g., z minutes), then the password or passcode may expire, and a new password or passcode may need to be generated. In other examples, the processing system may mediate a secure connection between the user endpoint device of the student and the network connected device by other means (e.g., tokens or other authentication techniques). In still other examples, rather than allowing the user endpoint device of the student to directly control the network connected device, the processing system may function as an intermediary (e.g., the user endpoint device of the student sends commands to the processing system, and, if the processing system confirms that the commands correspond to permissible actions, may then forward the commands to the network connected device).

In optional step 216 (illustrated in phantom), the processing system may monitor an interaction of the student with the learning activity (i.e., while the learning activity is in progress). For instance, the processing system may determine whether a signal has been received (e.g., from the user endpoint device of the student, from the server hosting the learning activity, etc.) to indicate that the student has completed the learning activity. If applicable, the signal may also include some indication as to the student's comprehension of the learning activity (e.g., if the learning activity included a quiz, the signal may include the student's score on the quiz).

As another example, if the student begins a learning activity that requires some form of occasional input from the student (e.g., answering a question, responding to a prompt designed to determine whether the student is still paying attention, controlling a network connected device to perform an action, etc.), the processing system may be notified when the student has not provided the requested input after a predefined threshold period of time following the request (e.g., the student has not answered the question after y seconds). Failure to respond within the threshold period of time may be an indication that the student has stopped paying attention or is having difficulty with the learning activity.

As another example, if the student begins a learning activity that requires the student to answer occasional questions about the material being presented in the learning activity, the processing system may be able to monitor what percentage of the questions the student is answering correctly. If the percentage falls below a predefined threshold percentage, this may indicate that the student is struggling with the learning activity, and that perhaps a learning activity with a lower level of difficulty is appropriate or the learning activity presented in a different learning style might be better suited for the student.

In optional step 218 (illustrated in phantom) the processing system may determine, based on the monitoring, whether the student has completed the learning activity. For instance, as discussed above, the processing system may receive a signal to indicate when the student has completed the learning activity.

If the processing system determines in step 218 that the student has not completed the learning activity, then the method 200 may return to step 216, and the processing system may continue to monitor the interaction of the student with the learning activity.

If, however, the processing system determines in step 218 that the student has completed the learning activity, then the method 200 may proceed to step 220. In optional step 220 (illustrated in phantom), the processing system may receive feedback from the student about the learning activity. In one example, the feedback may be received from the student in response to a prompt from the processing system.

In one example, the feedback may indicate how the student perceived the difficulty level of the learning activity. For instance, the processing system may ask the student to select a rating that indicates how difficult the student found the learning activity to be. This feedback may be compared to the level of difficulty indicated in the profile for the learning activity (e.g., to determine how well the level of difficulty indicated in the profile for the learning activity reflects the actual difficulty of the learning activity). Similarly, the feedback may indicate whether the student found the learning style of the learning activity to be effective or not. This feedback may be compared to the preferred learning style indicated in the profile for the student (e.g., to determine whether the preferred learning style indicated in the profile for the student is actually the most effective learning style for the student).

In optional step 222 (illustrated in phantom), the processing system may modify at least one of: the profile of the student or the profile of the learning activity based on at least one of the feedback or the monitoring.

For instance, in one example, the profile of the student may be modified to indicate that the student completed the learning activity. This may allow the student to subsequently access other learning activities for which the learning activity is a prerequisite. The profile of the student could also be modified to indicate whether the learning style of the learning activity is preferred or not preferred by the student, based on the feedback. Similarly, if the monitoring indicates that the student was likely having difficulty completing the learning activity, or difficulty paying attention to the learning activity, this may indicate that the student's preferred level of difficulty should be adjusted, or that the learning style of the learning activity should not be preferred by the student.

In another example, the profile of the learning activity may be modified. For instance, if multiple students who completed (or at least began) the learning activity indicated that the level of difficulty of the learning activity was higher than indicated by the profile for the learning activity, or if multiple students seemed to struggle with completing the learning activity, then the profile for the learning activity may be modified to adjust the indicated level of difficulty. Additionally, further review might determine that the level of difficulty of the learning activity is appropriate, but that another learning activity should be designated as a prerequisite in order to facilitate better comprehension of the learning activity (e.g., a learning activity that teaches conjugation of French verbs would be easier to understand if a learning activity that teaches French pronouns is completed first). Similarly, the learning style indicated in the profile for the learning activity could be modified to indicate that students who prefer a certain learning style have difficulty with the learning activity.

The updated profile information for both the student and for the learning activity could be used by the processing system to make future recommendations of learning activities, both to the student and to other students.

The method 200 may end in step 224.

Thus, the method 200 can provide a more targeted learning experience for students based on the students' preferred styles of learning. For instance, different students may participate in learning activities that teach the same subject matter, just in different styles that are tailored for the students' individual preferences and abilities. Moreover, examples of the present disclosure can provide educators with student feedback on the students' learning experiences, which may be tightly integrated with the students' learning choices. Feedback from students can be pooled and analyzed in a manner that helps educators to improve learning activities as well as the manner in which learning activities are recommended and presented to students.

Examples of the present disclosure may also be leveraged to expand on the current home-to-classroom remote learning model to enable other models, including classroom-to-classroom, classroom-to-venue, and classroom-to-expert. These expansions may provide students with access to learning opportunities that might not otherwise be available due to distance, cost, safety, lack of access to resources, and/or other factors. For instance, students may be able to remotely explore a historical site or museum on the other side of the world from the classroom, or to connect with a subject matter expert for specialized instructions on a topic.

In further examples, extended reality technologies (e.g., augmented reality and/or virtual reality) may also be leveraged in combination with examples of the present disclosure to enhance remote “field trips,” e.g., by generating virtual signage for museum visits or observing wildlife in natural settings, providing virtual tour guides for historic sites, and the like.

Classroom-to-classroom and classroom-to-expert models could also be further enhanced by assigning individual user endpoint devices to each student (e.g., placing a tablet computer including a camera and microphone at each student's desk in a classroom), so that each student has the opportunity for personalized individual interactions.

Although not expressly specified above, one or more steps of the method 200 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

FIG. 3 depicts a high-level block diagram of a computing device or computing system specifically programmed to perform the functions described herein. For example, any one or more components or devices illustrated in FIG. 1 or described in connection with the method 200 may be implemented as the computing system 300. For instance, an application server of a remote learning system (such as might be used to perform the method 200) could be implemented as illustrated in FIG. 3.

As depicted in FIG. 3, the computing system 300 comprises a hardware processor element 302, a memory 304, a module 305 for supporting the personalization of remote learning experiences, and various input/output (I/O) devices 306.

The hardware processor 302 may comprise, for example, a microprocessor, a central processing unit (CPU), or the like. The memory 304 may comprise, for example, random access memory (RAM), read only memory (ROM), a disk drive, an optical drive, a magnetic drive, and/or a Universal Serial Bus (USB) drive. The module 305 for supporting the personalization of remote learning experiences may include circuitry and/or logic for performing special purpose functions relating to the allocation of network resources. The input/output devices 306 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computing system 300 may employ a plurality of processor elements. Furthermore, although only one computing system is shown in the Figure, if the method(s) as discussed above is implemented in a distributed or parallel manner for a particular illustrative example, i.e., the steps of the above method(s) or the entire method(s) are implemented across multiple or parallel computing system, then the computing system of this Figure is intended to represent each of those multiple computing systems. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for supporting the personalization of remote learning experiences (e.g., a software program comprising computer-executable instructions) can be loaded into memory 304 and executed by hardware processor element 302 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for supporting the personalization of remote learning experiences (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
receiving, by a processing system including at least one processor, a selection of a learning activity by a student;
retrieving, by the processing system, a profile for the learning activity;
retrieving, by the processing system, a profile for the student;
determining, by the processing system, that no conflict exists between the profile for the learning activity and the profile for the student; and
delivering, by the processing system in response to the determining, the learning activity to a user endpoint device of the student, wherein the delivering includes granting the user endpoint device of the student a control over a network connected device that is located in a separate physical environment from the user endpoint device of the student.

2. The method of claim 1, wherein the learning activity comprises a remote learning activity, and the remote learning activity comprises a media file that is stored in a database and downloaded or streamed for play back on the user endpoint device of the student.

3. The method of claim 1, wherein the profile for the learning activity specifies at least one of: a learning style of the learning activity, a level of difficulty of the learning activity, a target age level of the learning activity, or a prerequisite for the learning activity.

4. The method of claim 3, wherein the learning style of the activity comprises at least one of: an interactive discussion, a hands-on activity, a lecture, or a learning by reading.

5. The method of claim 3, wherein the profile of the student specifies at least one of: a preferred learning style of the student, a learning history of the student, an age of the student, or a preferred level of difficulty of the student.

6. The method of claim 5, wherein the learning history of the student includes other learning activities that the student has previously completed with assistance from the processing system.

7. The method of claim 5, wherein the determining comprises confirming that the learning style of the learning activity to match the preferred learning style of the student.

8. The method of claim 5, wherein the determining comprises confirming that the target age level of the learning activity to match the age of the student.

9. The method of claim 5, wherein the determining comprises confirming that the level of difficulty of the learning activity to match the preferred level of difficulty of the student.

10. The method of claim 5, wherein the determining comprises confirming that the learning history of the student includes a completion of all prerequisites associated with the learning activity.

11. The method of claim 1, further comprising, prior to the determining:
determining, by the processing system, that a conflict exists between a profile for a previously selected learning activity and the profile for the student; and
prompting, by the processing system, the student to select from among a list of alternate learning activities, wherein the learning activity is selected from the list of alternate learning activities.

12. The method of claim 1, wherein the learning activity comprises a first version of a lesson presented in a first learning style, and wherein other versions of the lesson in other styles are also available to be selected.

13. The method of claim 1, wherein the network connected device comprises at least one of: an internet of things device, a multimedia device, a piece of scientific equipment, a robot, a drone, or an electronic copy of a document.

14. The method of claim 1, further comprising:
monitoring, by the processing system, an interaction of the student with the learning activity; and
modifying at least one of: the profile of the student or the profile of the learning activity based on the monitoring.

15. The method of claim 1, further comprising:
receiving, by the processing system, feedback from the student about the learning activity; and
modifying at least one of: the profile of the student or the profile of the learning activity based on the feedback.

16. The method of claim 1, wherein the learning activity is one of a plurality of learning activities stored in a learning activity database.

17. The method of claim 1, wherein the profile of the student is curated by an educator of the student.

18. The method of claim 1, wherein an educator may override a conflict that is detected between the profile for the learning activity and the profile for the student.

19. A non-transitory computer-readable medium storing instructions which, when executed by a processing system including at least one processor, cause the processing system to perform operations, the operations comprising:
receiving a selection of a learning activity by a student;
retrieving a profile for the learning activity;
retrieving a profile for the student;
determining that no conflict exists between the profile for the learning activity and the profile for the student; and
delivering, in response to the determining, the learning activity to a user endpoint device of the student, wherein the delivering includes granting the user endpoint device of the student a control over a network connected device that is located in a separate physical environment from the user endpoint device of the student.

20. A device comprising:
a processing system including at least one processor; and
a computer-readable medium storing instructions which, when executed by the processing system, cause the processing system to perform operations, the operations comprising:
receiving a selection of a learning activity by a student;
retrieving a profile for the learning activity;
retrieving a profile for the student;
determining that no conflict exists between the profile for the learning activity and the profile for the student; and
delivering, in response to the determining, the learning activity to a user endpoint device of the student, wherein the delivering includes granting the user endpoint device of the student a control over a network connected device that is located in a separate physical environment from the user endpoint device of the student.
